(19) United States
(12) Patent Application Publication
(10) Pub. No.: US 2026/0346935 A1
(43) Pub. Date: Nov. 5, 2026

(54) ASSEMBLY TO LOCK BICYCLES TO ONE ANOTHER

(71) Applicant: Also, Inc., Palo Alto, CA (US)

(72) Inventor: Jonathan Louis HALL, Menlo Park, CA (US)

(73) Assignee: Also, Inc., Palo Alto, CA (US)

(21) Appl. No.: 19/196,308

(22) Filed: May 1, 2025

(51) Int. Cl. B62H 5/00; B62J 43/16; B62J 43/30; B62M 6/55

(52) U.S. Cl. CPC B62H 5/006; B62J 43/16; B62J 43/30; B62M 6/55

(57) ABSTRACT

A bicycle can include a structure and an assembly. The structure can support the bicycle. The assembly can include a first end and a second end. The first end can fixably couple with a first portion of the structure. The second end can fixably couple with a second portion of the structure. The first end and the second end can define an opening to receive a lock.

### SUMMARY

This disclosure is generally related to one or more components of a bicycle. The components can include at least one of assemblies, sub-assemblies, modules, systems, platforms, or components. For example, the bicycle can include an assembly coupled with at least one structure of the bicycle. The structure can include at least one of a frame, a tube, a body, a housing, or other possible component of the bicycle. For example, the assembly can be coupled with a frame (e.g., the structure) of the bicycle. The assembly can include one or more ends, segments, portions, or sections. For example, the assembly can include a first end and a second end. The first end or the second end can couple with one or more portions of the structure (e.g., the frame, a seat tube, etc.).

At least one aspect is directed to a bicycle. The bicycle can include a structure. The structure can support the bicycle. The bicycle can include an assembly. The assembly can include a first end. The first end can fixably couple with a first portion of the structure. The assembly can include a second end. The second end can fixably couple with a second portion of the structure. The first end and the second end can define an opening to receive a lock.

At least one aspect is directed to an assembly. The assembly can include a first end. The first end can fixably couple with a first portion of a structure of a bicycle. The assembly can include a second end. The second end can fixably couple with a second portion of the structure. The first end and the second end can define an opening to receive a lock.

At least one aspect is directed to a structure. The structure can be for a bicycle. The structure can include a first portion. The first portion can fixably couple with a first end of an assembly. The structure can include a second portion. The second portion can fixably couple with a second end of the assembly. The first end and the second end can define an opening to receive a lock.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a bicycle, in accordance with some aspects.

FIG. 2 depicts the bicycle of FIG. 1, in accordance with some aspects.

FIG. 3 depicts a perspective view of a first bicycle and a second bicycle, in accordance with some aspects.

FIG. 4 depicts a perspective view of a first bicycle and a second bicycle, in accordance with some aspects.

FIG. 5 depicts a perspective view of a first bicycle and a second bicycle, in accordance with some aspects.

FIG. 6 depicts a perspective view of a first bicycle and a second bicycle, in accordance with some aspects.

FIG. 7 is a flow diagram of a process for an assembly, in accordance with some aspects.

FIG. 8 is a block diagram illustrating an architecture for a computer system, in accordance with some aspects.

### DETAILED DESCRIPTION

Following below are more detailed descriptions of various concepts related to, and implementations of, methods, apparatuses, and systems of one or more assemblies for a bicycle. The various concepts introduced above and discussed in greater detail below may be implemented in any of numerous ways.

The present disclosure is directed to one or more components for a bicycle. The components can include one or more assemblies, systems, modules, elements, or components. For example, the bicycle can include an assembly. The assembly can couple with or be secured to one or more structures of the bicycle. For example, the assembly can couple with a frame of the bicycle. As another example, the assembly can couple with a seat tube of the bicycle. The assembly can include at least one opening or gap. For example, the assembly can include a first end and a second end to define the opening. The opening can receive, accept, or otherwise allow for a member of a lock to pass through or otherwise navigate. The lock, upon passing through the opening, can lock or otherwise secure the bicycle to another object. For example, the lock can secure (e.g., lock) the bicycle to a second bicycle. As another example, the lock can secure the bicycle to a post.

Operators of bicycles or other rideable vehicles often travel to various locations or destinations, which upon arrival typically park or otherwise leave the bicycles. Some locations can include designated areas to place the bicycles, however the number of slots (e.g., spaces, areas, regions, etc.) that include structures to secure the bicycles to is often limited. As a result, some operators of bicycles may come across locations that lack or are without slots to secure the bicycles upon departure from the bicycles. This disparity can lead to congestion and inconvenience for cyclists, who struggle to find secure spots to park their bikes. As urban areas increasingly promote cycling as a sustainable mode of transportation, the demand for bike parking continues to rise. However, the infrastructure to support this growth is lagging behind which results in overcrowded bike racks and bikes being parked without being secure to objects.

The disclosed solutions have a technical advantage of providing one or more assemblies to provide openings or areas for which a member of a lock can pass through. For example, the assembly can include one or more ends to couple with a structure of the bicycle. The assembly, upon fixably coupling with the structure, can define an opening for the member of the lock to pass through. The member can lock the bicycle to one or more objects by coupling with or otherwise securing to a body of the lock. The location, on the bicycle, of the assembly can be selected such that the opening aligns or is otherwise positioned proximate or adjacent to a second opening of a second bicycle. For example, the assembly can be placed on a first location of the structure such that, upon placing or aligning the bicycle next to a second bicycle, the assembly aligns with a second assembly of the second bicycle. The first location can correspond to or otherwise match a location for which the second assembly is placed on the second bicycle.

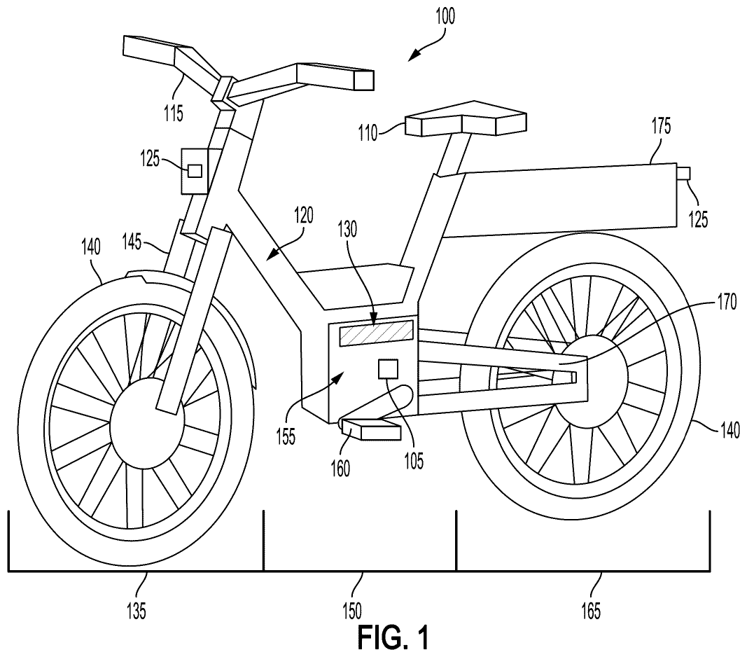

FIG. 1 depicts an example perspective view of a bike 100. The bike 100 can be an electric bike installed with at least one battery pack 105. The bike 100 can include at least one bicycle. The bike 100 can be a human-operated bike. The bike 100 can include single rider bicycles, tandem bicycles, cargo bicycles, motor-assist bicycles, pedicabs, electric-assist bicycles, road bicycles, mountain bicycles, or unicycles, among others. The battery pack 105 can also be used as an energy storage system to power a building, such as a residential home or commercial building. The bike 100 can be fully electric or partially electric (e.g., pedal-powered) and further, the bike 100 can be fully autonomous, partially autonomous, semi-autonomous, or unmanned. The bike 100 can also be human operated or non-autonomous.

A human operator or rider of the bike 100 can sit on a seat 110 to operate the bike 100. The rider of the bike 100 can steer, grip, balance, or otherwise control the bike 100 using handlebar 115. The rider or operator of the bike 100, for which the seat 110 can support, can refer to or include a primary occupant of the bike 100.

The bike 100 can include a frame 120. The frame 120 can support various components of the bike 100, such as the handlebar 115, the seat 110, the battery pack 105, and at least one light 125. The frame 120 can span a front portion 135. The front portion 135 can support, be coupled with, or include, for example, a wheel 140 of the bike 100, a fork 145 of the bike 100, the handlebar 115, the light 125, among other components. The bike 100 can include two or more wheels 140 (e.g., a front wheel 140 and a rear wheel 140).

The frame 120 can span a middle portion 150. The middle portion 150 can support, be coupled with, or include, for example, the seat 110, the battery pack 105, a crank shaft or drive mechanism 155 of the bike 100, or a pedal 160 of the bike 100, among other components. The frame 120 can include a rear portion 165. The rear portion 165 can support, be coupled with, or include, for example, a rear wheel 140 of the bike 100, the light 125, a drive train 170 of the bike 100, a rack assembly 175 of the bike 100, or among other components. The battery pack 105 can be disposed anywhere within the frame 120. The drive mechanism 155 can refer to or include a series propulsion system.

The battery pack 105 can include at least one battery, at least one battery module, or at least one battery cell. The battery pack 105 can be electrically coupled with the bike 100 (e.g., the drive mechanism 155, the light 125, or some other components). For example, the battery pack 105 can provide electrical energy to the bike 100 to power the bike 100.

The battery pack 105 can be installed or placed within the bike 100. For example, the battery pack 105 can be installed on the frame 120 of the bike 100 within one or more of the front portion 135, the middle portion 150, or the rear portion 165. The battery pack 105 can be integrally coupled with the frame 120 such that it is not removable. The battery pack 105 can be detachably coupled with the frame 120 such that in can be removed (e.g., to charge the battery pack 105).

The battery pack 105 can include or connect with at least one busbar, e.g., a current collector element. For example, the busbar can include electrically conductive material to connect or otherwise electrically couple the battery pack 105 with other electrical components of the bike 100 to provide electrical power to various systems or components of the bike 100, such as the drive mechanism 155, or some other system.

The bike 100 can include one assemblies electrically coupled with the battery pack 105. For example, the battery pack 105 can be electrically coupled with a receiver of an assembly to facilitate the actuation or movement of one or more components of the receiver. In this way, the receiver can be configured to be controlled or actuated electronically via power provided by the battery pack 105, rather than being controlled or actuated manually or mechanically (e.g., via some manual action of an operator). The battery pack 105 can provide power to other components of the bike 100 (e.g., the drive mechanism 155, the light 125, or some other component) simultaneously, separately, in sequence, or in some other manner.

The bike 100 can be electrically propelled or manual propelled. For example, the bike 100 can include a series hybrid propulsion system. As another example, the battery pack 105 can provide power to the drive mechanism 155 to power the drive train 170 to propel the bike 100 (e.g., propel the bike by causing the at least one wheel 140 to rotate). As another example, an operator of the bike 100 can operate or otherwise move the pedals 160 to manual move or power the drive train 170.

The bike 100 or one or more components thereof can include at least one processing circuit 130. For example, a controller of the bike 100 can include the processing circuit 130. As another example, the processing circuit 130 can be included in a control mechanism that facilitates control (e.g., lock, unlock, actuation, etc.) of an electronic lock or electronic lock mechanism. The processing circuit 130 can refer to or include one or more processors and memory. For example, the processing circuit 130 can include one or more processors that are coupled with memory. Memory can refer to or include one or more of hardware devices or storage devices that can store instructions (e.g., executable code, firmware, software, functions, etc.). The instructions can, when executed by the one or more processors, cause the one or more processors to implement at least one process, action, step, or function described herein. The processing circuit 130 can be electrically coupled with the battery pack 105 to receive power from the battery pack 105.

The processing circuit 130 can be communicably coupled with one or more components of the bike 100. For example, the processing circuit 130 can communicate with the battery pack 105 to control a discharge of power by the battery pack 105. As another example, the processing circuit 130 can provide, generate, or otherwise transmit one or more signals, which cause the drive mechanism 155 to activate or deactivate. As even another example, the processing circuit 130 can transmit one or more signals to a locking mechanism of the bike 100. The processing circuit 130 can detect one or more inputs. For example, the processing circuits 130 can detect inputs, received by a network interface of the bike 100, to lock or unlock a lock or locking mechanism of the bike 100. Stated otherwise, the processing circuit 130 can detect one or more inputs provided to or received by the bike 100 or one or more components thereof. The inputs can include one requests to lock or unlock a locking mechanism of an electronic lock.

The processing circuit 130 can implement or otherwise execute one or more control actions based on detected inputs. For example, the processing circuit 130 can actuate or otherwise control a locking mechanism to lock or unlock a lock that is securing the bike 100 to one or more objects. Stated otherwise, the processing circuit 130 can control the lock mechanism to switch a lock from a locked state to an unlocked state or vice versa. The processing circuit 130 can establish communication with one or more components of the bike. For example, the processing circuit 130 can establish communication with an electronic lock. As another example, the processing circuit 130 can establish communication with one or more computing devices (e.g., smart phone, tablet, computer, server, remote system, etc.). The processing circuit 130 can establish communication by transmitting one or more signals. For example, the processing circuit 130 can transmit one or more signals, via a controller area network (CAN) bus, to establish communication. As another example, the processing circuit 130 can transmit one or more signals, via a network interface, to establish communication.

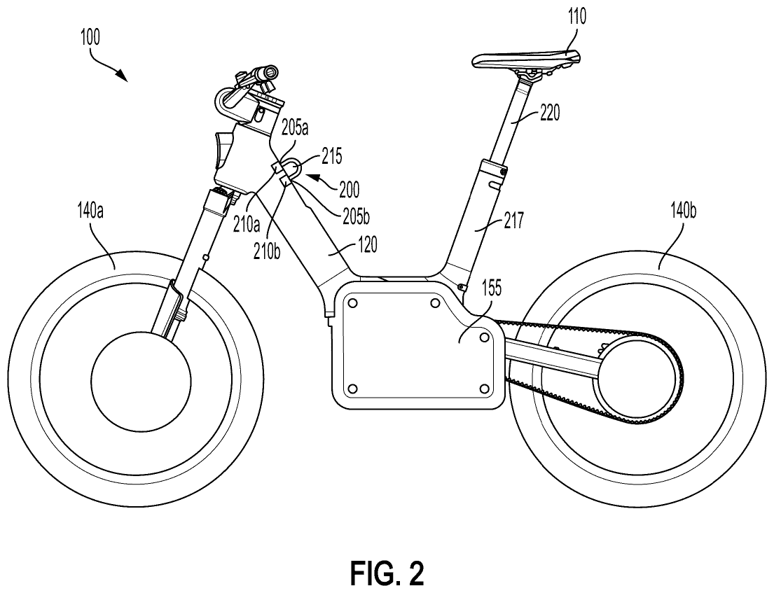

FIG. 2 depicts the bike 100, in accordance with some aspects. The view of the bike 100, as shown in FIG. 2, can refer to or include a side-view. The bike 100 or one or more components thereof can include sub-components, structures, assemblies, sub-assemblies, elements, modules, or members. For example, as shown in FIG. 2, the bike 100 includes an assembly 200. As another example, as shown in FIG. 2, the bike 100 includes a seat tube 217.

The seat tube 217 can be included in the frame 120 or part of the frame 120. The seat tube 217 can be discrete or separate from the frame 120. For example, the frame 120 can represent a first component of the bike 100 and the seat tube 217 can represent a second component of the bike 100. The seat tube 217 can receive or otherwise accept at least one post 220. For example, the seat tube 217 can include an opening for which the post 220 can be inserted into. The post 220 can refer to or include a seat post. The post 220 can receive or otherwise couple with the seat 110. For example, the post 220 can couple with the seat 110 to provide structural support to the seat 110. The bike 100 can include at least one structure to couple with or otherwise receive the assembly 200. For example, the seat tube 217 (e.g., the structure) can couple with the assembly 200. As another example, the frame 120 (e.g., the structure) can couple with the assembly 200.

The assembly 200 can be located at or disposed on one or more portions or areas of the bike 100. For example, as shown in FIG. 2, the assembly 200 is disposed on or otherwise included with the frame 120 (e.g., a structure). As another example, the assembly 200 can be disposed on the seat tube 217. The assembly 200 can be coupled with one or more components of the bike 100. For example, the assembly 200 can be electrically coupled with the battery pack 105 such that the assembly 200 can receive electrical energy from the battery pack 105. As another example, the assembly 200 can be communicably coupled with the drive train 170 such that the assembly 200 can send signals to or receive signals from the drive train 170. As another example, the assembly 200 can be communicably coupled with the processing circuit 130 to control operation of the assembly 200 or one or more components thereof (e.g., a lock, a locking mechanism, etc.).

The assembly 200 can be integrated with at least one structure of the bike 100 such that at least a portion or segment of the assembly 200 is unified with the bike 100. Stated otherwise, a housing or other possible assembly (which defines a component of the bike 100) can include at least a portion of the assembly 200. For example, at least a portion of the assembly 200 can be integrated with a housing of the frame 120. As another example, at least a portion of the assembly 200 can be welded to or otherwise attached to the seat tube 217.

The assembly 200 can include one or more of ends, portions, segments, sections, or regions. For example, as shown in FIG. 2, the assembly 200 includes a first end 205a and a second end 205b. The ends (e.g., the first end 205a, the second end 205b, etc.) of the assembly 200 can define at least one opening 215. For example, the first end 205a and the second end 205b can define a shape, a dimension, a size, or an arrangement of a gap (e.g., the opening 215) for which a lock can pass through. The opening 215 can be disposed superior to (e.g., above) one or more components of the bike 100. For example, as shown in FIG. 2, the opening 215 is disposed superior to at least one wheel (e.g., the front wheel 140a, the rear wheel 140b, etc.) of the bike 100. As another example, as shown in FIG. 2, the opening 215 is disposed superior to the drive mechanism 155 of the bike 100. The location of the opening 215 can be selected or designated such that an operator of the bike 100 can access, from a standing position, the opening 215.

The ends of the assembly 200 can couple with at least one structure of the bike 100. For example, as shown in FIG. 2, the first end 205a is coupled with a first portion 210a of the frame 120 (e.g., a structure) and the second end 205b is coupled with a second portion 210b of the frame 120. The ends of the assembly 200 can be fixably coupled with one or more portions of the structure. For example, the first end 205 can be welded to the first portion 210a. As another example, the second end 205 can be attached, via one or more fasteners, to the second portion 210b.

The assembly 200 or one or more components thereof can include one or more dimensions, sizes, lengths, areas, or shapes. For example, the assembly 200 can include a length that spans from the first end 205a to the second end 205b. Stated otherwise, the assembly 200 can include a longitudinal dimension that runs or originates at the first end 205a and ends or terminates at the second end 205b. The length of the assembly 200 can be relative to one or more components of the bike 100. For example, the length of the assembly 200 can be less than, equal to, or greater than a distance between the first portion 210a and the second portion 210b. The distance between the first portion 210a and the second portion 210b can refer to or include a spacing or a separation between the first portion 210a and the second portion 210b. The distance between the first portion 210a and the second portion 210b can include one or more values or ranges. For example, the distance between the first portion 210a and the second portion 210b can be 10 inches. As another example, the distance between the first portion 210a and the second portion 210b can be greater than 15 inches. As even another example, the distance between the first portion 210a and the second portion 210b can include a range of 4 inches to 20 inches.

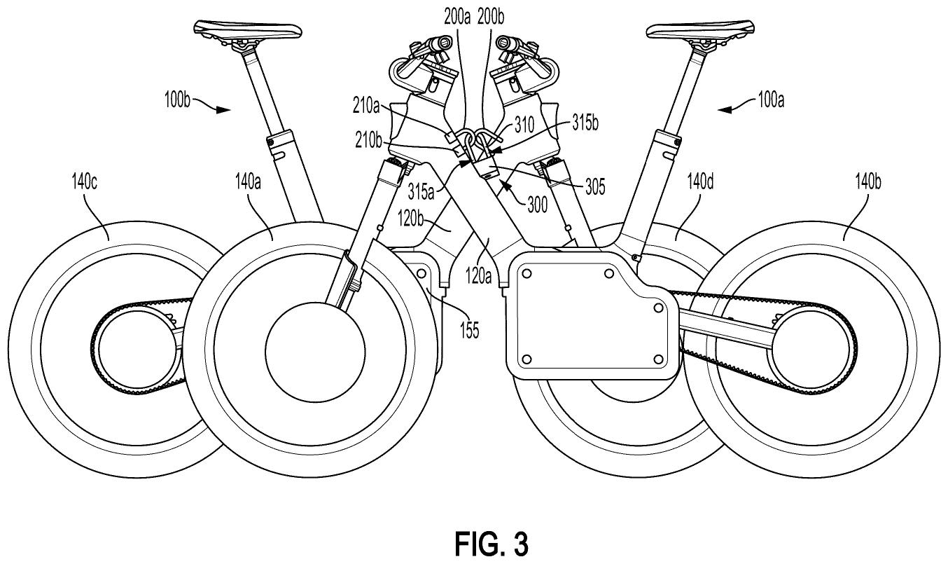

FIGS. 3-6 depict perspective views of a first bicycle and a second bicycle. The bicycles (as shown in FIGS. 3-6) can include the bike 100. For example, the first bicycle can include the bike 100a and the second bicycle can include the bike 100b. As shown in FIG. 3, a lock 300 can pass through or navigate through an assembly 200a and an assembly 200b. The assembly 200a can be included in the bike 100a and the assembly 200b can be included in the bike 100b. The lock 300 can be separate from the bikes (e.g., the bike 100a, the bike 100b, etc.). For example, the lock 300 can refer to or include at least one of a padlock, a U-lock, a chain lock, a folding lock, a cable lock, a disk lock, among other possible separate or discrete locks with respect to the bikes.

The lock 300 can include at least one body 305 and at least one member 310. The body 305 can refer to or include a housing to receive or accept a locking mechanism of the lock 300. For example, the body 305 can provide a structure or a space for which the locking mechanism of the lock 300 can be situated or otherwise located. The body 305 can include a crossbar, a locking bar, a lock, a lock housing, or a locking mechanism. The member 310 can refer to or include at least one of a shackle, a U-bolt, a lock arm, a lock loop, or a locking bar. The member 310 can include at least one portion. For example, as shown in FIG. 3, the lock 300 includes a first portion 315a and a second portion 315b. At least one portion of the lock 300 can be fixably coupled with the body 305. For example, the first portion 315a can be fixably coupled with the body 305 such that the first portion 315a does not detach or separate from the body 305 with the locking mechanism of the lock 300 in an unlocked state. At least one portion of the lock 300 can pass through one or more openings. For example, as shown in FIG. 3, the second portion 315b has passed through the opening of the assembly 200a and the opening of the assembly 200b. The second portion 315b can pass through the openings such that, upon the second portion 315b coupling with the body 305, the bike 100a and the bike 100b are locked to one another. Stated otherwise, the second portion 315b can (while detached, decoupled, or separated from the body 305) pass through the openings and then couple with the body 305 to lock the bike 100a and the bike 100b together.

The portions of the structure can be selected or otherwise designated (to receive or couple with the assembly 200) such that the opening 215 is positioned or otherwise located (upon alignment with a second bicycle) proximate to an opening of the second bike. For example, as shown in FIG. 3, the first portion 210a and the second portion 210b (of the bike 100a) are selected such that the opening of the assembly 200a is positioned proximate to the opening of the assembly 200b. The opening of the assembly 200a or the opening of the assembly 200b can be positioned proximate to one another with at least one component of the bike 100a positioned adjacent to at least one component of the bike 100b. For example, as shown in FIG. 3, the opening of the assembly 200a and the opening of the assembly 200b are positioned proximate to one another with the front wheel 140a of the bike 100a positioned adjacent to the drive mechanism 155 of the bike 100b. As another example, the opening of the assembly 200a can be disposed proximate to the opening of the assembly 200b with the frame 120a of the bike 100a adjacent to the frame 120b of the bike 100b. Stated otherwise, the opening of the assembly 200a can align with the opening of the assembly 200b when the frame 120a of the bike 100a is next to or near the frame 120b of the bike 100b.

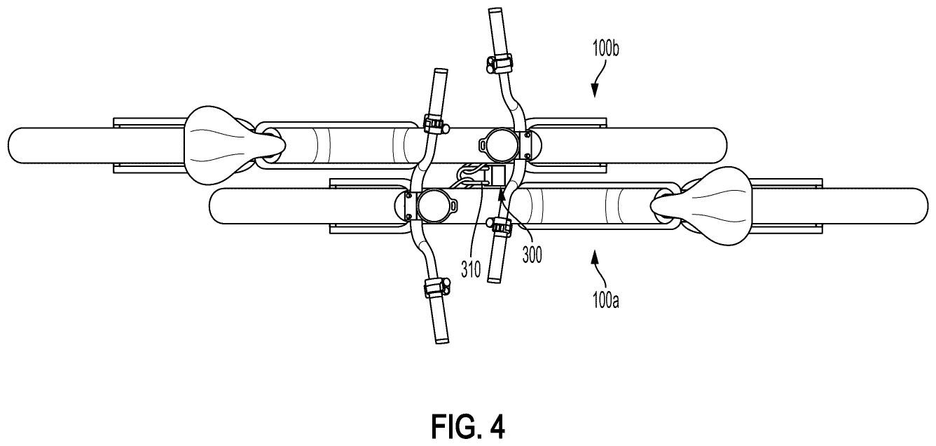

The bike 100a and the bike 100b can include a space or gap between another with the bike 100a and the bike 100b locked, via the lock 300, with another. For example, as shown in FIG. 4, the bike 100a and the bike 100b include a space between one another such that the bike 100a and the bike 100b do not touch or otherwise contact one another while locked by the lock 300. Stated otherwise, the bike 100a and the bike 100b can be slightly separated or spaced apart while also being locked, via the lock 300, to one another.

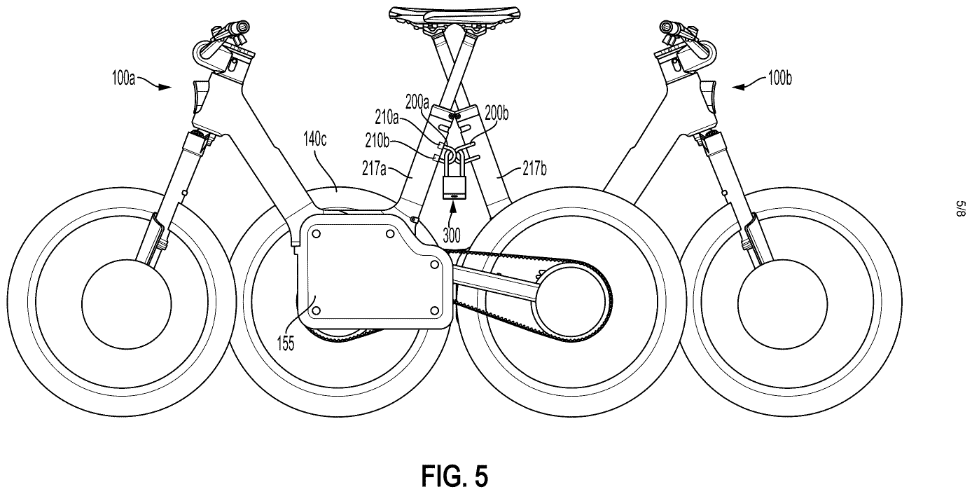

The assembly 200 can fixably couple with the seat tube 217 (e.g., the structure) of the bike 100. For example, as shown in FIG. 5, the assembly 200a is fixably coupled with the seat tube 217a and the assembly 200b is fixably coupled with the seat tube 217b. The placement of the assembly 200 (along, across, or within the structure) can be selected based on an arrangement or configuration of the bike 100 while the bike 100 is proximate to a second bike. For example, as shown in FIG. 5, the placement (on the seat tube 217a) of the opening of the assembly 200a and the placement (on the seat tube 217b) of the opening of the assembly 200b are selected such that the openings are positioned proximate to one another with the rear wheel 140c of the bike 100b positioned adjacent to the drive mechanism 155 of the bike 100a. As another example, the opening of the assembly 200a and the opening of the assembly 200b can be positioned proximate to one another with the seat tube 217a positioned adjacent to the seat tube 217b. Stated otherwise, the opening the assembly 200a and the opening of the assembly 200b can be positioned proximate to one another when the seat tube 217a is abut to or otherwise near the seat tube 217b.

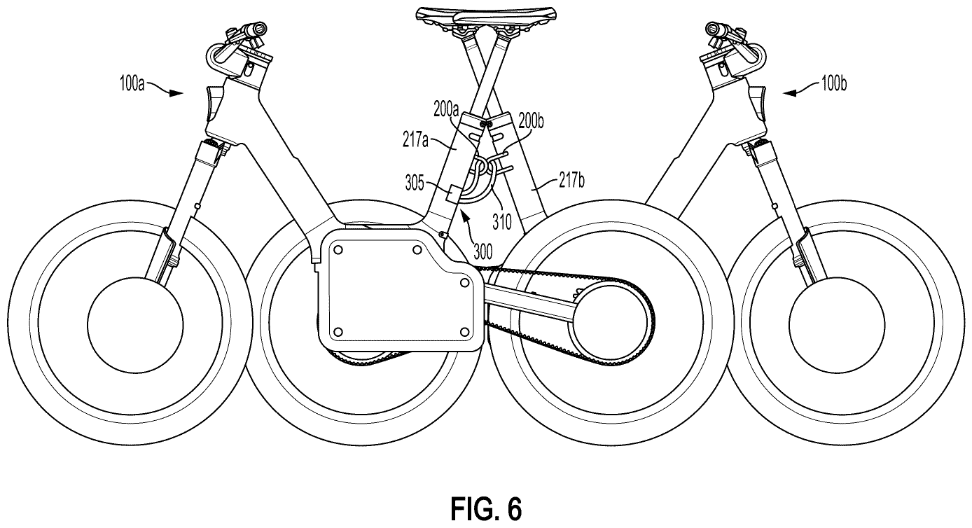

The lock 300 can be included with or otherwise integrated with at least one component of the bike 100. For example, as shown in FIG. 6, the body 305 is integrated with the seat tube 217a of the bike 100a. The body 305 can be integrated with the structure (e.g., the frame 120, the seat tube 217, etc.) by at least one of placing, positioning, locating, or otherwise situating the body 305 at least partially within the structure of the bike 100. Stated otherwise, at least a portion of the lock 300 or one or more components thereof can be included within at least one component of the bike 100. The lock 300 can refer to or include an electronic lock. For example, the processing circuits 130 can facilitate control (e.g., lock, unlock, etc.) of the lock 300.

The lock 300 or one or more components thereof can expand or retract (relative to the bike 100). For example, the member 310 can extend from or retract into the frame 120. Stated otherwise, the member 310 can telescope, collapse, lengthen, shorten, or otherwise adjust such that member 310 can move from a position at least partially within the frame 120 to a position at least partially outside of the frame 120 or vice versa. As shown in FIG. 6, the member 310 can extend, from the seat tube 217a, to pass through or otherwise navigate through the opening of the assembly 200a and the opening of the assembly 200b.

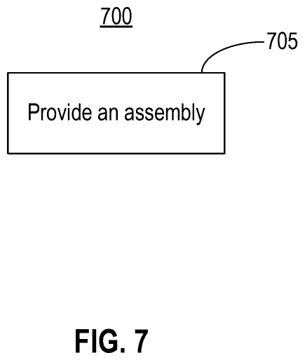

FIG. 7 is a flow diagram of a process 700, in accordance with some aspects. The process 700 can include manufacturing, providing, packaging, or otherwise making available at least one component described herein. For example, the process 700 can include the packaging of the assembly 200. As another example, the process 700 can include placing or otherwise situating the assembly 200 on the bike 100.

At act 705, an assembly can be provided. For example, an assembly that includes the first end 205a and the second end 205b can be provided. As another example, an assembly for inclusion in the bike 100 can be provided. The assembly can be provided by at least one of coupling, securing, attaching, or otherwise mounting the assembly to a bike. For example, one or more ends of the assembly can be welded to or otherwise attached to one or more portions of a structure of the bike. As another example, the assembly can be retrofitted to bike 100 subsequent to manufacturing or otherwise assembling the bike. Stated otherwise, the assembly can be provided as an add-on to the bike 100.

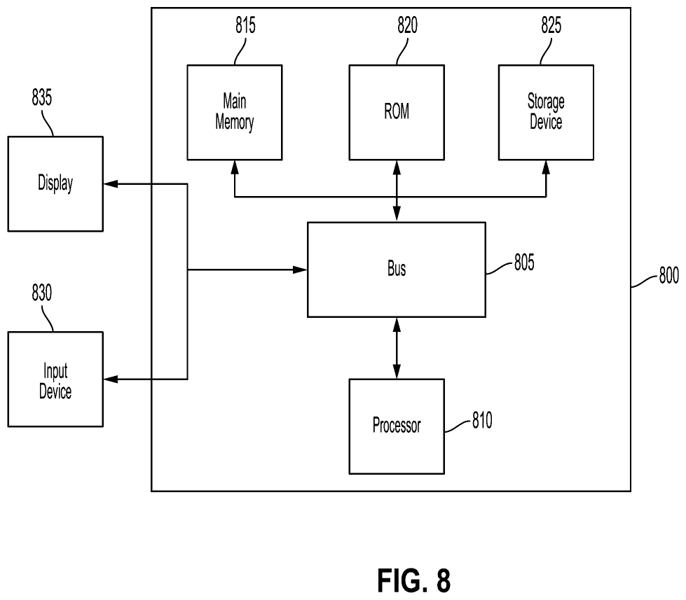

FIG. 8 is a block diagram illustrating an architecture for a computer system 800 that can be employed to implement elements of the systems, methods, and assemblies described and illustrated herein. For example, the computer system 800 can be included in or provided with the processing circuit 130. The computing system 800 can include at least one bus 805 or other communication component for communicating information and at least one processor 810 or processing circuit coupled to the bus 805 for processing information. The computing system 800 can also include one or more processors 810 or processing circuits coupled to the bus for processing information. The computing system 800 also includes at least one main memory 815, such as a random access memory (RAM) or other dynamic storage device, coupled to the bus 805 for storing information, and instructions to be executed by the processor 810. The main memory 815 can be used for storing information during execution of instructions by the processor 810. The computing system 800 may further include at least one read only memory (ROM) 820 or other static storage device coupled to the bus 805 for storing static information and instructions for the processor 810. A storage device 825, such as a solid state device, magnetic disk or optical disk, can be coupled to the bus 805 to persistently store information and instructions.

The computing system 800 may be coupled via the bus 805 to a display 835, such as a liquid crystal display, or active matrix display, for displaying information to a user such as a rider of the bike 100 or other end user. An input device 830, such as a keyboard or voice interface may be coupled to the bus 805 for communicating information and commands to the processor 810. The input device 830 can include a touch screen display 835. The input device 830 can also include a cursor control, such as a mouse, a trackball, or cursor direction keys, for communicating direction information and command selections to the processor 810 and for controlling cursor movement on the display 835.

The processes, systems and methods described herein can be implemented by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors in a multi-processing arrangement may also be employed to execute the instructions contained in main memory 815. Hard-wired circuitry can be used in place of or in combination with software instructions together with the systems and methods described herein. Systems and methods described herein are not limited to any specific combination of hardware circuitry and software.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, and although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

Further relative parallel, perpendicular, vertical, or other positioning or orientation descriptions include variations within +/−10% or +/−10 degrees of pure vertical, parallel, or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A bicycle, comprising:
a structure to support the bicycle; and
an assembly, including:
a first end to fixably couple with a first portion of the structure;
a second end to fixably couple with a second portion of the structure; and
the first end and the second end configured to define an opening to receive a lock.

2. The bicycle of claim 1, comprising:
the lock configured to integrate at least partially within the structure; and
the lock, including:
a body; and
a member, including:
a first portion to fixably couple with the body; and
a second portion configured to:
pass through both the opening and a second opening of a second bicycle; and
removably couple with the body to lock the bicycle with the second bicycle.

3. The bicycle of claim 1, comprising:
the first portion of the structure and the second portion of the structure selected such that the opening is positioned proximate to a second opening of a second bicycle with at least one of:
a front wheel of the bicycle positioned adjacent to a drive mechanism of a second bicycle; or
a rear wheel of the bicycle positioned adjacent to the drive mechanism of the second bicycle.

4. The bicycle of claim 1, wherein the lock includes an electronic lock integrated with the bicycle, comprising:
one or more processors, coupled with memory, to:
establish communication with the electronic lock; and
receive one or more inputs to lock or unlock a locking mechanism of the electronic lock.

5. The bicycle of claim 1, comprising:
the opening disposed superior to at least one wheel of the bicycle; and
the opening disposed superior to a drive mechanism of the bicycle.

6. The bicycle of claim 1, comprising:
a distance between the first portion of the structure and the second portion of the structure greater than 10 inches; and
a length, along the assembly and spanning from the first end to the second end, less than the distance.

7. The bicycle of claim 1, wherein the structure includes a frame of the bicycle, and comprising:
the opening to dispose proximate to a second opening of a second bicycle with the frame adjacent to a second frame of the second bicycle.

8. The bicycle of claim 1, wherein the structure includes a seat tube of the bicycle, and comprising:
the opening to dispose proximate to a second opening of a second bicycle with the seat tube adjacent to a second seat tube of the second bicycle.

9. The bicycle of claim 1, comprising:
a series hybrid propulsion system; and
one or more batteries configured to:
provide power to the series hybrid propulsion system; and
provide power to one or more processors, coupled with memory, that control the lock.

10. An assembly, comprising:
a first end to fixably couple with a first portion of a structure of a bicycle;
a second end to fixably couple with a second portion of the structure; and
the first end and the second end configured to define an opening to receive a lock.

11. The assembly of claim 10, wherein:
the lock is configured to integrate at least partially within the structure; and
the lock includes:
a body; and
a member, including:
a first portion to fixably couple with the body; and
a second portion configured to:
pass through both the opening and a second opening of a second bicycle; and
removably couple with the body to lock the bicycle with the second bicycle.

12. The assembly of claim 10, wherein the first portion of the structure and the second portion of the structure are selected such that the opening is positioned proximate to a second opening of a second bicycle with at least one of:
a front wheel of the bicycle positioned adjacent to a drive mechanism of a second bicycle; or
a rear wheel of the bicycle positioned adjacent to the drive mechanism of the second bicycle.

13. The assembly of claim 10, wherein the lock includes an electronic lock integrated with the bicycle, and wherein the bicycle includes one or more processors, coupled with memory, to:
establish communication with the electronic lock; and
receive one or more inputs to lock or unlock a locking mechanism of the electronic lock.

14. The assembly of claim 10, comprising:
the opening disposed superior to at least one wheel of the bicycle; and
the opening disposed superior to a drive mechanism of the bicycle.

15. The assembly of claim 10, comprising:
a distance between the first portion of the structure and the second portion of the structure greater than 10 inches; and
a length, along the assembly and spanning from the first end to the second end, less than the distance.

16. The assembly of claim 10, wherein the structure includes a frame of the bicycle, and comprising:
the opening to dispose proximate to a second opening of a second bicycle with the frame adjacent to a second frame of the second bicycle.

17. The assembly of claim 10, wherein the structure includes a seat tube of the bicycle, comprising:
the opening to dispose proximate to a second opening of a second bicycle with the seat tube adjacent to a second seat tube of the second bicycle.

18. The assembly of claim 10, wherein the bicycle includes a series hybrid propulsion system, and wherein the bicycle includes one or more batteries configured to:
provide power to the series hybrid propulsion system; and
provide power to one or more processors, coupled with memory, that control the lock.

19. A structure for a bicycle, the structure comprising:
a first portion to fixably couple with a first end of an assembly; and
a second portion to fixably couple with a second end of the assembly;
wherein the first end and the second end define an opening to receive a lock.

20. The structure of claim 19, wherein the first portion and the second portion are selected such that the opening is positioned proximate to a second opening of a second bicycle with at least one of:
a front wheel of the bicycle positioned adjacent to a drive mechanism of a second bicycle; or
a rear wheel of the bicycle positioned adjacent to the drive mechanism of the second bicycle.
